(19) United States
(12) Patent Application Publication
(10) Pub. No.: US 2015/0037569 A1
(43) Pub. Date: Feb. 5, 2015

(54) REFLECTIVE COATING SYSTEMS FOR REFLECTOR LAMPS, METHODS THEREFOR, AND LAMPS EQUIPPED THEREWITH

(71) Applicant: GENERAL ELECTRIC COMPANY, Schenectady, NY (US)

(72) Inventors: Peter William BROWN, Twinsburg, OH (US); Tianji ZHAO, Highland Heights, OH (US)

(73) Assignee: GENERAL ELECTRIC COMPANY, Schenectady, NY (US)

(21) Appl. No.: 13/957,477

(22) Filed: Aug. 2, 2013

(51) Int. Cl. F21V 7/22; C23C 30/00; B05D 7/00; B05D 7/22; G02B 5/08; B05D 5/06

(52) U.S. Cl. CPC F21V 7/22; G02B 5/0808; B05D 5/068; B05D 7/5783; B05D 7/22; C23C 30/00
USPC 428/336; 428/704; 427/230

(57) ABSTRACT

Reflective coating systems, methods for depositing such coating systems, and lamps equipped with such coating systems. The reflective coating systems include an intermediate metallic layer overlying a substrate and consisting of nickel, chromium or a Ni—Cr alloy, a reflective metallic layer containing silver and overlying the intermediate metallic layer, and a protective layer overlying the reflective metallic layer.

### BACKGROUND OF THE INVENTION

The present invention generally relates to coating compositions and methods. More particularly this invention relates to reflective coating systems suitable for use in reflector lamps.

Reflector lamps have various applications, nonlimiting examples of which include spot lights and head lamps. Particular examples of reflector lamps include PAR (parabolic aluminized reflector) 38 and PAR 64 lamps available from various manufacturers. Reflective coatings are often deposited on the interior surface of a glass substrate housing of a reflector lamp to improve reflectance of the lamp. U.S. Pat. No. 6,773,141 describes reflector lamps and reflective coatings, and the contents of this patent relating thereto are incorporated herein by reference.

In recent years, considerable emphasis has been placed on increasing energy efficiency in reflector lamps. Energy efficiency is measured in the industry in lumens produced by a lamp per watt (LPW) of electricity input to the lamp. Lamps with higher LPW are more energy efficient than those with lower LPW. Consequently, improvements are often sought to maintain or enhance the LPW of lamps in cost-effective ways without compromising efficiency and aesthetics. As an example, a lamp can employ a reflective coating to reduce light absorption by the lamp housing and/or increase the lumens of light transmitted through a lens or other transparent section of the lamp, offering the potential to increase the efficiency of the lamp. Reflectance is typically indicated as a ratio of the total amount of light reflected by a surface to the total amount of radiation incident on the surface.

In the lighting industry, commonly used reflective coatings include aluminum and silver metallic films (coatings). Methods of achieving these coatings are described in U.S. Pat. No. 6,773,141 and elsewhere and therefore will not be described in any detail here. Silver metallic films may require protection to prevent certain undesirable consequences, including oxidation at lamp operating temperatures and chemical attack. For this reason, protective coatings have been developed which include, but are not limited to, silicon dioxide (SiO₂) films. Reflective silver metallic films may also require a sufficient thickness to survive harsh manufacturing conditions. Because reflective coatings that contain silver can significantly increase the cost of a reflector lamp due to the high cost of silver, there is an ongoing desire for reflective coatings that are less expensive than relatively thick silver reflective coatings. Further, any new reflective coating would desirably maintain the reflectance and the cosmetic appearance of the lamp when viewed from within and outside the lamp. Thus a need exists for reflective coatings capable of achieving reflectance comparable to silver films while reducing material costs and maintaining the overall cosmetic appearance of a reflector lamp.

### BRIEF DESCRIPTION OF THE INVENTION

The present invention provides reflective coating systems suitable for use in lamps, such as, but not limited to, PAR lamps, as well as methods of forming such coating systems. Embodiments of this invention further relate to lamps that include such reflective coating systems.

According to a first aspect of the invention, a substrate is provided with a reflective coating system comprising an intermediate metallic layer that overlies the substrate and consists of nickel, chromium, or a Ni—Cr alloy, a reflective metallic layer that contains silver and overlies the intermediate metallic layer, and a protective layer that overlies the reflective metallic layer. In this aspect of the invention, the intermediate metallic layer constitutes at least 20 percent of a combined thickness of the intermediate metallic layer and the reflective metallic layer.

According to a second aspect of the invention, a lamp is provided with a substrate and a reflective coating system on the substrate. The reflective coating system comprises an intermediate metallic layer that overlies the substrate and consists of nickel, chromium, or a Ni—Cr alloy, a reflective metallic layer that contains silver and overlies the intermediate metallic layer, and a protective layer that overlies the reflective metallic layer. The intermediate metallic layer constitutes at least 20 percent of a combined thickness of the intermediate metallic layer and the reflective metallic layer.

According to a third aspect of the invention, a method is provided for producing a lamp to have a reflective interior surface. The method comprises depositing an intermediate metallic layer consisting of nickel, chromium, or a Ni—Cr alloy to overlie a substrate of the lamp, depositing a reflective metallic layer containing silver to overlie the intermediate metallic layer, and depositing a protective layer to overlie the reflective metallic layer. The intermediate metallic layer constitutes at least 20 percent of a combined thickness of the intermediate metallic layer and the reflective metallic layer.

A technical effect of the invention is the capability of reflective coatings of this invention to achieve reflectance properties and cosmetic appearances that are substantially similar to certain prior art reflective coatings, while also potentially reducing material costs.

Other aspects and advantages of this invention will be better appreciated from the following detailed description.

### BRIEF DESCRIPTION OF THE DRAWINGS

FIG. 1 is a perspective view of a reflector lamp of a type capable of being provided with a reflective coating system of this invention.

FIG. 2 is a cross-sectional view of the lamp of FIG. 1.

FIG. 3 is an enlarged cross-sectional view of a portion of a substrate region of the reflector lamp of FIG. 2 illustrating a reflective coating system in accordance with an embodiment of the present invention.

FIG. 4 is an enlarged cross-sectional view of a portion of a substrate region of the reflector lamp of FIG. 2 illustrating a reflective coating system in accordance with another embodiment of the present invention.

### DETAILED DESCRIPTION OF THE INVENTION

Embodiments described herein generally relate to reflective coatings employed in reflector lamps such as, but not limited to, PAR 38 and PAR 64 lamps. In particular, combinations of metallic reflective coating layers and optional intermediate and protective coating layers are described in order to achieve a desired level of reflectivity, maintain a desirable cosmetic appearance, and reduce the cost of materials for such coatings. While the invention will be described in reference to reflector lamps, those skilled in the art will appreciate that the teachings of this invention will find applications in products and technologies other than lamps.

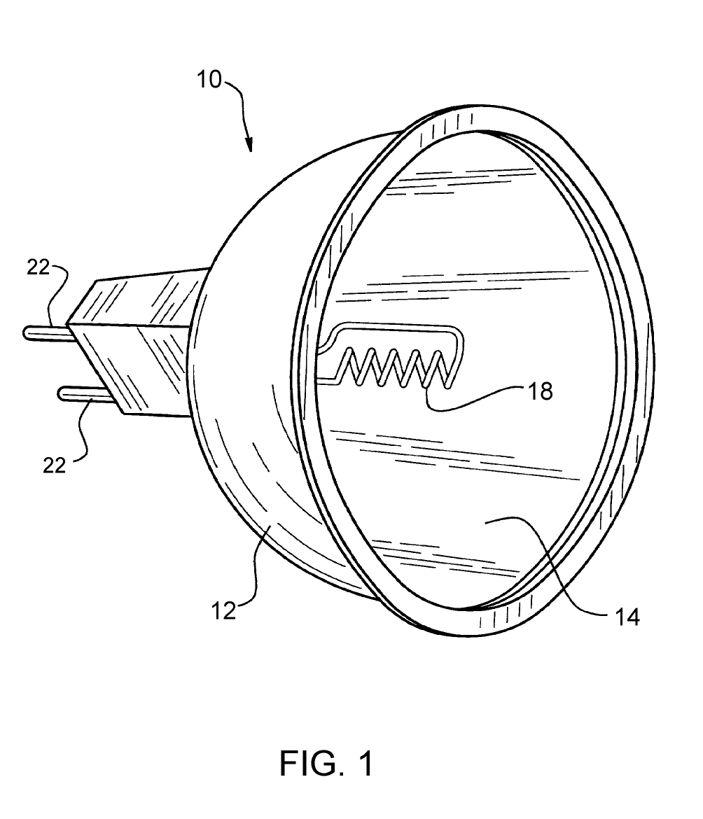

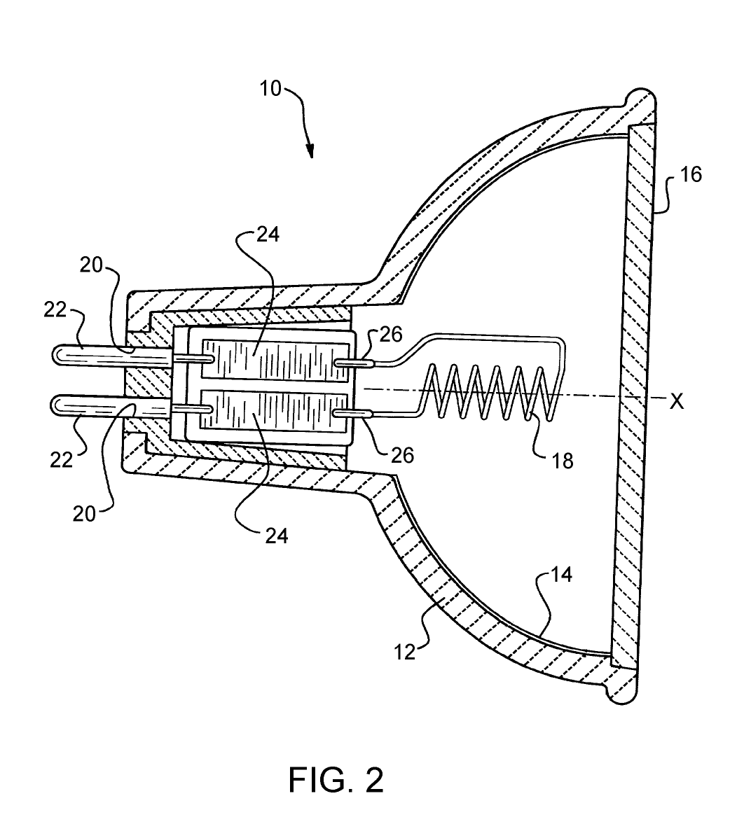

The present invention is discussed below in reference to FIGS. 1-4. FIGS. 1 and 2 represent a lamp 10 and a cross-sectional view of the lamp 10, respectively. The lamp 10 comprises a parabolic-shaped reflector housing 12 having a substrate on which an interior reflective coating system 14 has been formed. In certain embodiments the substrate is glass or another transparent material, though substrates formed of other materials including translucent and opaque materials are also foreseeable, nonlimiting examples of which include steel, copper, aluminum, or any other metal that can be produced by stamping, die-casting or another metal-forming process, plastics including polycarbonate, porcelain, enamels, and ceramic materials. In FIG. 2, one end of the reflector housing 12 is represented as being closed with a lens 16. The lens 16 is preferably intended to be transparent to visible light and may include a filter to absorb/reflect the light dispersed by a filament 18 within the housing 12. The lens 16 may further include an anti-reflection coating to enhance light transmission, and may incorporate additional design features to satisfy the particular requirements of the lamp 10.

Referring again to FIG. 2, the end of the reflector housing 12 opposite the lens 16 includes two pass-through channels 20 that accommodate leads or ferrules 22. The leads 22 make electrical contact with foils 24, which in turn are electrically connected with leads 26 to the filament 18. In this manner, electricity is provided to the filament 18, enabling the filament 18 to serve as a light source. From FIG. 2, it is apparent that the longitudinal axis X of the filament 18 lies on the axis of the parabolic-shaped reflector housing 12.

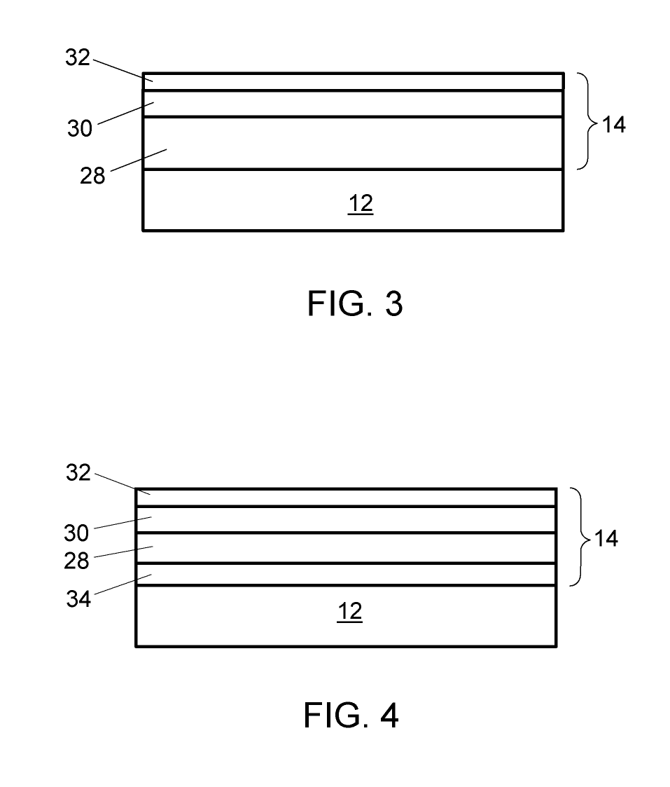

FIG. 3 is an enlarged cross-sectional view of a portion of the substrate of the reflector housing 12, and schematically represents individual layers 28, 30 and 32 of the reflective coating system 14. It should be noted that the layers 28, 30 and 32 shown in FIG. 3 are schematic representations and are not to scale. Further, in FIG. 3, the curvature of the reflector housing 12, and hence that of the layers 28, 30 and 32, is not depicted. According to one aspect of the invention, the layers 28, 30 and 32 of the reflective coating system 14 are, respectively, an intermediate metallic layer 28, a reflective metallic layer 30, and an outermost protective layer 32. The inclusion of additional layers within the coating system 14 is foreseeable.

In preferred embodiments of the invention for the coating system 14 of FIG. 3, the intermediate metallic layer 28 overlies and preferably directly contacts the substrate of the housing 12. The intermediate metallic layer 28 preferably consists of nickel, chromium, or a Ni—Cr alloy thereof, along with incidental impurities. Particular Ni—Cr alloys of interest contain at least 20 weight percent nickel, with the balance chromium and incidental impurities, for example, alloys containing about 20, 40, 50, 60, or 80 weight percent nickel with the balance chromium and impurities. The reflective metallic layer 30 overlies the intermediate metallic layer 28, preferably directly contacts the intermediate metallic layer 28, and preferably is thinner than the intermediate metallic layer 28. Preferred compositions for the reflective metallic layer 30 contain silver, and more preferably the reflective metallic layer 30 is entirely silver. The layer 32 is described herein as being protective in the sense that it prevents or at least inhibits degradation of the reflective properties of the reflective metallic layer 30, for example, from oxidation at lamp operating temperatures, from chemical attack, etc. As such, the protective layer 32 overlies the reflective metallic layer 30 and preferably directly contacts the reflective metallic layer 30. Particularly suitable materials for the protective layer 32 include dielectric oxides, nitrides, and fluorides, nonlimiting examples of which include silica (SiO₂), alumina (Al₂O₃), titania (TiO₂), tantala (Ta₂O₅), silicon nitride (Si₃N₄), and magnesium fluoride (MgF₂). Though represented as an individual layer, the protective layer 32 can comprise multiple layers of one or more dielectric oxides, nitrides, and/or fluorides.

The intermediate metallic layer 28 preferably constitutes at least 20 percent of the combined thickness of the intermediate and reflective metallic layers 28 and 30, and in some embodiments may constitute 75 percent or more of the combined thickness of the intermediate and reflective metallic layers 28 and 30. A preferred thickness for the intermediate metallic layer 28 is in a range of about 50 to about 400 nm, more preferably about 100 to about 200 nm, and nominally about 200 nm. A preferred thickness for the reflective metallic layer 30 is about 60 to about 400 nm, more preferably about 100 to about 200 nm, and nominally about 150 nm. The protective layer 32 may have a thickness of about 10 to about 200 nm, more preferably about 30 to about 200 nm, and nominally about 30.

The intermediate metallic layer 28 preferably functions as an opaque barrier layer within the coating system 14 and may be less reflective than the reflective metallic layer 30, yet reduces the thickness required of the reflective metallic layer 30 to survive harsh manufacturing conditions of the type often involved in deposition processes, for example, when depositing the layers 28, 30 and 32 of the coating system 14. As a result, the thickness of the reflective metallic layer 30 can be considerably less than that of reflective metallic layers of the prior art, with the result that the overall material cost of the lamp 10 may be reduced. Thus, use of the above mentioned set of metallic layers 28 and 30 can provide a cost advantage in the fabrication of the reflective coating system 14 for the lamp 10. Evaluations have shown that reflectances of parabolic reflector lamps provided with coating systems l4 of the type represented in FIG. 3 were about 90 to about 98%, which is similar to prior art silver metallic coatings having substantially higher thicknesses of about 450 nm.

FIG. 4 is another enlarged cross-sectional view of the lamp 10 of FIG. 2, but illustrates another aspect of the invention that entails the use of an interior metallic layer 34, in addition to the reflective and intermediate metallic layers 30 and 28 discussed above in reference to the embodiment of FIG. 3. Again, it should be noted that the layers 28, 30, 32 and 34 shown in FIG. 4 are schematic representations and are not to scale. Further, in FIG. 4, the curvature of the reflector housing 12, and hence that of the layers 28, 30, 32, and 34, is not depicted. According to this aspect of the invention, the interior metallic layer 34 is between the intermediate metallic layer 28 and the substrate of the housing 12. According to one embodiment, the interior metallic layer 34 is formed of a material that is more reflective than the intermediate metallic layer 30, for example, is formed of aluminum or silver. According to another embodiment, the interior metallic layer 34 may be formed of copper or another material having an aesthetically pleasant appearance. In some cases, a barrier layer (not shown) may be desirable to inhibit any potential reaction between the interior metallic layer 34 and other layers of the coating system 14. Suitable materials for this purpose include those identified above for the protective layer 32. In preferred embodiments of the invention, the interior metallic layer 34 has a thickness of less than the intermediate metallic layer 28, and furthermore also preferably has a thickness of not greater than the reflective metallic layer 30. For example, the interior metallic layer 34 may have a thickness of about 40 to about 200 nm, more preferably about 60 to about 100 nm, and nominally about 150 nm. In this embodiment, the intermediate metallic layer 28 preferably constitutes at least 10 percent of a combined thickness of the intermediate metallic layer 28, the reflective metallic layer 30, and the interior metallic layer 34.

At the thicknesses disclosed above, when disposed between the intermediate metallic layer 28 and the substrate of the housing 12, the interior metallic layer 34 is preferably capable of an ornamental function by concealing the intermediate metallic layer 28 from view if the lamp housing 12 is formed of glass (or another transparent material) and observed from the exterior of the lamp 10. Evaluations have shown that the reflectance and cosmetic appearance of a parabolic reflector lamp provided with the coating system 14 of FIG. 4 were substantially similar to prior art silver metallic coatings having substantially higher thicknesses of about 450 nm. As an alternative to the interior metallic layer 34, its desired effect can be otherwise achieved if the intermediate metallic layer 28 is formed of a Ni—Cr alloy and deposited under a controlled low vacuum to avoid discoloration of the Ni—Cr alloy.

Methods of producing coating systems 14 in accordance with the embodiments discussed above can be achieved by sequentially depositing the optional interior metallic layer 34, the intermediate metallic layer 28, and then the reflective metallic layer 30 on the substrate of the reflector housing 12. Suitable deposition techniques include sputtering, thermal evaporation, ion-assisted deposition (IAD), physical vapor deposition (PVD), or chemical vapor deposition (CVD) and other known processes such as dip coating, with sputtering and thermal evaporation believed to be preferred. The protective layer 32 can also be deposited by conventional techniques, for example, sputtering, thermal evaporation, and CVD, particularly plasma-enhanced chemical vapor deposition (PECVD). The as-coated reflector housing 12 is then preferably heated to a temperature at which oxygen is able to diffuse into the protective layer 32 to fill voids and increase the density of the protective layer 32. For example, during manufacture of the lamp housing 12 the protective layer 32 may be subjected to a temperature within a range of about 100 to about 300° C., at which oxygen from the surrounding ambient air is available to diffuse into the protective layer 32.

In view of the above, it is believed that the embodiments described here for the reflective coating systems 14 are advantageously capable of reducing material costs without compromising, or at minimum not significantly compromising, the reflectance, energy efficiency and cosmetic appearance of lamps utilizing the coating systems 14. It should be noted that it may be possible to use different material sets or different thicknesses for the layers 28, 30, 32, and 34 described above, yet achieve similar results.

While the invention has been described in terms of specific embodiments, it is apparent that other forms could be adopted by one skilled in the art. Therefore, the scope of the invention is to be limited only by the following claims.

1. A reflective coating system on a surface of a substrate, the reflective coating system comprising an intermediate metallic layer overlying the substrate and consisting of nickel, chromium, or a Ni—Cr alloy, a reflective metallic layer containing silver and overlying the intermediate metallic layer, and a protective layer overlying the reflective metallic layer.

2. The reflective coating system according to claim 1, wherein the intermediate metallic layer constitutes at least 20 percent of the combined thickness of the intermediate metallic layer and the reflective metallic layer.

3. The reflective coating system according to claim 2, wherein the intermediate metallic layer has a thickness of about 50 nm to about 400 nm.

4. The reflective coating system according to claim 1, wherein the reflective metallic layer has a thickness of about 60 nm to about 400 nm.

5. The reflective coating system according to claim 1, wherein the protective layer is chosen from the group consisting of dielectric oxides, nitrides and fluorides.

6. The reflective coating system according to claim 1, wherein the intermediate metallic layer contacts the substrate.

7. The reflective coating system according to claim 1, wherein the reflective metallic layer contacts the intermediate metallic layer.

8. The reflective coating system according to claim 1, wherein the reflective metallic layer consists of silver.

9. The reflective coating system according to claim 1, wherein the substrate is a transparent material and the reflective coating system further comprises an interior metallic layer between the intermediate metallic layer and the substrate.

10. The reflective coating system according to claim 8, wherein the interior metallic layer consists of aluminum, silver, or copper.

11. The reflective coating system according to claim 1, wherein the substrate is a housing of a reflector lamp.

12. A lamp comprising a substrate and a reflective coating system on a surface of the substrate, the reflective coating system comprising an intermediate metallic layer overlying the substrate and consisting of nickel, chromium, or a Ni—Cr alloy, a reflective metallic layer containing silver and overlying the intermediate metallic layer, and a protective layer overlying the reflective metallic layer.

13. The lamp according to claim 12, wherein the intermediate metallic layer constitutes at least 20 percent of the combined thickness of the intermediate metallic layer and the reflective metallic layer.

14. The lamp according to claim 12, wherein the protective layer is chosen from the group consisting of dielectric oxides, nitrides and fluorides.

15. The lamp according to claim 12, wherein the intermediate metallic layer contacts the substrate.

16. The lamp according to claim 12, wherein the reflective metallic layer contacts the intermediate metallic layer.

17. The lamp according to claim 12, wherein the reflective metallic layer consists of silver.

18. The lamp according to claim 12, wherein the substrate is a transparent material, the reflective coating system further comprises an interior metallic layer between the intermediate metallic layer and the substrate, and the interior metallic layer consists of aluminum, silver, or copper.

19. A method of producing a lamp having a reflective interior surface, the method comprising:
depositing an intermediate metallic layer consisting of nickel, chromium, or a Ni—Cr alloy to overlie a substrate of the lamp;
depositing a reflective metallic layer containing silver to overlie the intermediate metallic layer; and
depositing a protective layer to overlie the reflective metallic layer.

20. The method according to claim 19, wherein the intermediate metallic layer constitutes at least 20 percent of a combined thickness of the intermediate metallic layer and the reflective metallic layer.
